(19) United States
(12) Patent Application Publication
(10) Pub. No.: US 2006/0280027 A1
(43) Pub. Date: Dec. 14, 2006

(54) Method and apparatus for mixing fluids

(75) Inventor: John L. Fulton, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/149,712

(22) Filed: Jun. 10, 2005

(51) Int. Cl. B01F 13/02

(52) U.S. Cl. 366/101

(57) ABSTRACT

The present invention generally relates to a method and apparatus for mixing of fluids. More particularly, the present invention relates to a method and apparatus for mixing fluids introduced into near-critical and supercritical fluids forming a fluid stream. In the fluid stream a density gradient is generated that induces a convective velocity resulting in rapid mixing. The invention has application in such commercial applications as semiconductor and wafer fabrication where rapid cycle times or rapid mixing of fluids are required and where low tolerances for residues are permitted.

### FIELD OF THE INVENTION

The present invention generally relates to a method and apparatus for mixing fluids. More particularly, the present invention relates to a method and apparatus for mixing fluids having different fluid properties, including, but not limited to, density, concentration and temperature into a bulk carrier fluid at near-critical and supercritical conditions. The invention finds application in such commercial processes as semiconductor wafer fabrication.

### BACKGROUND OF THE INVENTION

Various near-critical and supercritical fluids have been proposed for next-generation processing of semiconductor, wafer, and/or chip substrates given their valuable chemical properties. However, a current challenge in the implementation of such fluids is the need for (i) rapid mixing within a short distance or low volume of the mixing device, (ii) minimization of dead space volumes, and (iii) trace contaminant level rinsing for ultra-clean substrates. Conventional mixing devices and systems including static (bead) beds, impeller-based systems/devices, and saddle mixing systems/devices, or the like suffer from large surface areas and/or large dead space volumes that retain constituents and/or fluids whereby low contaminant levels are difficult or slow to achieve. Accordingly, new systems and devices are needed permitting fully streamlined and rapid mixing of fluids that address these critical manufacturing and fabrication requirements applicable for next-generation processing of semiconductor, wafer, and/or chip substrates.

### SUMMARY OF THE INVENTION

In one aspect, the invention is a method for rapidly mixing a fluid or a plurality of fluids, comprising the step of introducing a fluid or a plurality of fluids into a near-critical or super-critical carrier fluid forming a fluid stream, wherein the carrier fluid is a gas at standard temperature and pressure having a density above the critical density for the carrier fluid; and, wherein a density gradient is generated upon introduction of the fluid or plurality of fluids, the density gradient inducing a convective velocity in the fluid stream, rapidly mixing the fluid or plurality of fluids in the fluid stream thereby forming the substantially homogenous mixed fluid.

In an embodiment, the carrier fluid comprises carbon dioxide.

In another embodiment, a density gradient is directionally opposed to the direction of flow of the carrier fluid.

In another embodiment, a convective velocity is directionally oriented parallel to the direction of flow of the carrier fluid.

In another embodiment, a convective velocity is directionally opposed to the direction of flow of the carrier fluid.

In another embodiment, a density gradient is generated in conjunction with a concentration difference between fluid(s) in the fluid stream.

In another embodiment, a density gradient is generated in conjunction with a temperature difference between fluid(s) in the fluid stream.

In yet another embodiment, at least one of a plurality of fluids in a fluid stream comprises a solute, e.g., a surfactant and/or a co-surfactant, introduced in a substantially liquefied form.

In another aspect, the invention is a mixing apparatus for rapid mixing of fluids comprising at least one inlet for introducing a fluid or a plurality of fluids into a near-critical or super-critical carrier fluid forming a fluid stream, wherein the carrier fluid is a gas at standard temperature and pressure having a density above the critical density for the carrier fluid; an outlet for retrieving a substantially homogeneous mixed fluid; a mixing section operably disposed between the at least one inlet and the outlet having an inner bore of substantially uniform dimension generating a density gradient upon introduction of a fluid or a plurality of fluids, the density gradient inducing a convective velocity in the stream that rapidly mixes the fluid or the plurality of fluids forming the substantially homogenous mixed fluid.

In an embodiment of the invention, the mixing apparatus comprises a mixing section having a plurality of substantially vertically disposed mixing segments operatively coupled together.

In yet another embodiment, the mixing section is configured in a coil.

In yet another embodiment, the mixing section has an angular shape.

In yet another embodiment, the mixing section has a rectangular shape.

In yet another embodiment, the mixing section comprises a single mixing segment substantially vertically disposed generating a density gradient in either an upward or a downward direction.

### BRIEF DESCRIPTION OF THE DRAWINGS

A more complete appreciation of the invention will be readily obtained by reference to the following description of the accompanying drawings in which like numerals in different figures represent the same structures or elements.

FIG. 1 illustrates density gradient and convective velocity parameters for achieving mixing of fluids in accordance with the present invention.

FIG. 2a illustrates a mixing apparatus (section) configured in the form of a coil for mixing of fluids, according to an embodiment of the invention.

FIG. 2b illustrates a mixing apparatus configured in the form of a coil for mixing of fluids, according to yet another embodiment of the invention.

FIG. 3 illustrates a mixing section for mixing of fluids having a substantially sinusoidal shape, according to yet another embodiment of the invention.

FIG. 4 illustrates a mixing section for mixing of fluids having a substantially angular shape, according to still yet another embodiment of the invention.

FIG. 5 illustrates a mixing member for mixing of fluids having a rectangular shape, according to still yet another embodiment of the invention.

FIG. 6 illustrates a complete mixing system, according to an embodiment of the invention.

### DETAILED DESCRIPTION OF THE INVENTION

The term “laminar flow” as used herein refers to streamlined flow paths characterized by flow lines that are smooth, parallel, or collinear with essentially no mixing or turbulence. The term “turbulent flow” as used herein refers to non-streamlined flow paths characterized by flow lines that include a radial component, or are other than smooth, parallel, or collinear. As will be appreciated by those of skill in the art, mixing achieved in conjunction with the present invention is equally applicable to conditions of both laminar and well as turbulent flow. Thus, no limitations are hereby intended.

The term “gradient” as used herein refers to the difference or change in a measured or calculated parameter (e.g., density, velocity, temperature, concentration) between fluids as a function of a second measured or calculated parameter (e.g., time, position, or a derivative of density with respect to temperature at a constant concentration). In one illustrative example, a density gradient can be defined as the difference or change in density “ρ” (a first parameter) between two fluids as a function of the change in distance “x” or “L” (a second parameter), expressed mathematically as ∂ρ/∂x or ∂ρ/∂L. In another example, a concentration gradient can be defined as the difference in concentration of a specified solute between two fluids as a function of the change in distance, i.e., ∂C/∂x or ∂C/dL.

The carrier fluid (or bulk fluid) of the invention is a gas at standard temperature and pressure (STP) having a density above the critical density of the carrier fluid, encompassing both “near-critical” and “supercritical” fluids, as will be understood by those of skill in the art. Constituent gases for generating near-critical and super-critical fluids include, but are not limited to, carbon dioxide (CO₂), ethane (C₂H₆), ethylene (C₂H₄), propane (C₃H₈), butane (C₄H₁₀), sulfurhexafluoride (SF₆), Freon®, nitrogen (N₂), ammonia (NH₃), substituted derivatives thereof (e.g., chlorotrifluoroethane) and combinations thereof. Carbon dioxide (CO₂) is an exemplary fluid given its low surface tension (1.2 dynes/cm at 20° C., “Encyclopedie Des Gaz”, Elsevier Scientific Publishing, 1976, pg. 361) and useful critical conditions (T_{c}=31° C., P_{c}=72.9 atm (or 1,071 psi), CRC Handbook, 71^{st} ed., 1990, pg. 6-49) applicable to a host of manufacturing concerns.

The fluids of the invention also encompass liquids having reduced temperatures (Tᵣ=T/T_{c}) of greater than about 0.75, where T is the measured temperature and T_{c} is the critical temperature for the carrier fluid. The near-critical and supercritical fluids of the invention can further incorporate various reagents and solutes therein. Solutes, including, but not limited to, e.g., surfactants, co-surfactants, chemical agents, and/or other reactive reagents as described, e.g., in co-pending application (U.S. application Ser. No. 10/783,249) are suitable for use in conjunction with the invention, incorporated herein by reference in its entirety. Other compounds, e.g., as disclosed by Francis (J. Phys. Chem., 58, 1099-1114, 1954), may also find application as constituents of the fluids of the present invention. No limitations are intended.

Surfactants and co-surfactants include, but are not limited to, CO₂-philic, anionic, cationic, non-ionic, zwitterionic, reverse-micelle-forming, and combinations thereof. Anionic surfactants include, but are not limited to, e.g., fluorinated hydrocarbons, fluorinated surfactants, non-fluorinated surfactants, per-fluoro-poly-ether (PFPE) surfactants, PFPE carboxylates, PFPE ammonium carboxylates, PFPE phosphate acids, PFPE phosphates, fluorocarbon carboxylates, PFPE fluorocarbon carboxylates, PFPE sulfonates, PFPE ammonium sulfonates, fluorocarbon sulfonates, fluorocarbon phosphates, alkyl sulfonates, sodium bis-(2-ethyl-hexyl) sulfosuccinates, ammonium bis-(2-ethyl-hexyl) sulfosuccinates, and combinations thereof. Cationic surfactants include, but are not limited to, tetra-octyl-ammonium fluoride compounds. Non-ionic reverse micelle forming surfactants include, but are not limited to, e.g., the poly-ethylene-oxide-dodecyl-ether class of compounds, substituted derivatives thereof, and functional equivalents thereof. Zwitterionic reverse micelle forming surfactants include, but are not limited to, e.g., alpha-phosphatidyl-choline class of compounds, substituted derivatives thereof, and functional equivalents thereof. Reverse-micelle-forming co-surfactants include, but are not limited to, e.g., alkyl acid phosphates, alkyl acid sulfonates, alkyl alcohols, perfluoroalkyl alcohols, dialkyl sulfosuccinate surfactants, derivatives, salts, and functional equivalents thereof. Reverse-micelle-forming co-surfactants include, but are not limited to, e.g., sodium bis-(2-ethyl-hexyl) sulfosuccinates, ammonium bis-(2-ethyl-hexyl) sulfosuccinates, and equivalents thereof. Chemical agents include, but are not limited to, e.g., ethanolamine (HOCH₂CH₂NH₂), hydroxylamine (HO—NH₂), peroxides, organic peroxides (R—O—O—R′), hydrogen peroxide (H₂O₂), alcohols, water, and/or other reactive constituents.

Surfactants and/or other solutes can be pre-mixed for on-demand injection in a liquid form with various co-solvents including, but not limited to, dichloro-pentafluoro-propane (also known as HCFC-225®), polychlorotrifluoroethylene, trifluoro-trichloro-ethane (also known as CFC-113®), dihydrodecafluoropentane (also known as Vertrel-XF®), diethylether, or combinations thereof, and the like. Ratio of solute(s) to co-solvent is selected in the range from about 0.1:1 to about 10:1. More particularly, ratios are selected in the range from about 1:1 to about 5:1.

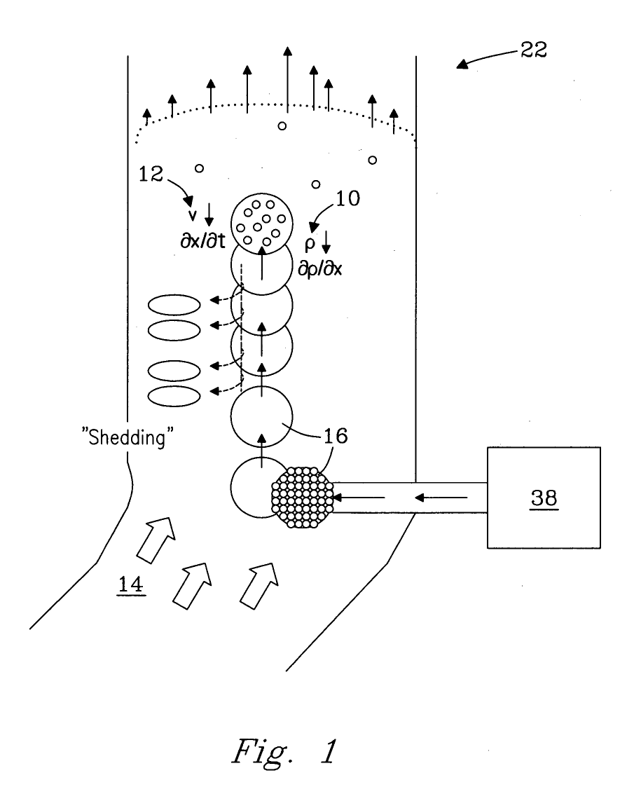

FIG. 1 illustrates mixing in a mixing apparatus 22 of a fluid 16 (or a plurality of fluids) introduced into a fluid 14 comprising, e.g., CO₂ or another bulk carrier fluid in a near-critical or super-critical state. In the figure, a localized “parcel” (packet) of fluid 16 comprising a solute is illustrated being introduced from a fluid reservoir 38 into fluid 14. Introduction of fluid 16 generates a density gradient having a vector (ρ) 10, the density gradient being defined as a function of density differences, i.e., ∂ρ/∂x. The density gradient induces a convective velocity vector (v) 12 defined as a function of changes in time (t) in the fluid stream, i.e., ∂x/∂t. Convective velocities induced in fluid 14 can be correlated to, and/or related by, Grashof numbers “Gᵣ” of the fluids being mixed or other fluids introduced thereto. The Grashof number is a dimensionless number from fluid dynamics which approximates the ratio of the buoyant force to the viscous force acting on a fluid, as defined by equation [1]:

$${G}_{r} = ( \frac{{D}^{3} {ρ}^{2} g ζ ( {C}_{s} - {C}_{0} )}{{μ}^{2}} ) \qquad [ 1 ]$$

where “g” is the gravitational constant; “70 ” (psi) is the volumetric expansion coefficient with concentration (having units 1/concentration) given by the expression [−/ρ*(∂ρ/∂C)_{(P,T)}]; D is the diameter of the mixing device; “Cₛ” is the concentration of the solute in fluid 16 introduced into carrier (bulk) fluid 14; “C₀” is the concentration of solute (normally 0, but not limited thereto) in the bulk carrier fluid 14; and “μ” is the viscosity of carrier fluid 14. As a consequence of the significant and/or large density differences (ζ*(Cₛ−C₀)) between bulk fluid 14 and fluid 16, substantial velocity gradients and/or vectors are generated. In particular, density differences (ζ*(Cₛ−C₀)) for fluids employed in conjunction with the invention are selected in the range from about 0.5 percent to about 200 percent. More particularly, density differences are selected in the range from about 10 percent to about 50 percent. The substantial velocities (velocity gradients) induced in near-critical and super-critical fluids of the invention provide for rapid mixing, as described hereinafter.

Various mass transfer properties of fluids are defined, e.g., by Bird et al. (in “Transport Phenomena”, John Wiley & Sons, New York, 1960, pg. 646). Rates of mixing (mass transfer) are known to correlate with Grashof numbers as described, e.g., by Joye et al. (Ind. Eng. Chem. Res. 1989, 28, 1899-1903; Int. J. Heat and Fluid Flow 17: 468-473, 1996; Ind. Eng. Chem. Res. 1996, 35, 2399-2403). For example, in near-critical and supercritical fluids, viscosities are from 5 to 50 times lower than for convention liquids. In addition, the volume expansion coefficient for near-critical and supercritical fluids is from 5 to 20 times higher than for conventional liquids. Given the low viscosity of near-critical and supercritical fluids of the invention, and the large volumetric expansion coefficient (psi), Grashof values for these fluids are about 3 orders of magnitude greater than for conventional liquids. Thus, at a minimum, rates of mixing for the invention are magnified by at least a factor of 3 when compared to rates of mixing in conventional liquids.

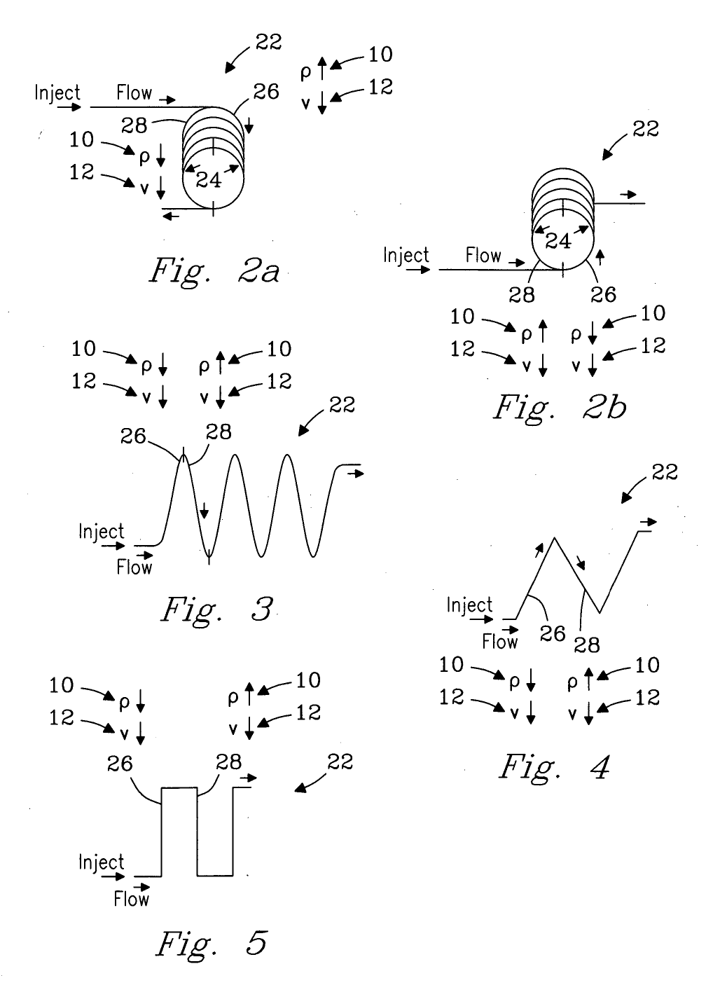

In general, as will be understood by those of skill in the art, density gradients and velocities are a function of other fluid parameters, including, but not limited to, e.g., solute concentration, temperature. Thus, no limitation in scope of the invention is intended by reference to specific density and/or velocities described herein. A mixing apparatus of the invention will now be described with reference to FIG. 2a and FIG. 2b.

FIG. 2a illustrates a mixing apparatus 22 (section) for mixing of fluids, according to an embodiment of the invention. Mixing section 22 comprises any number of substantially vertically disposed mixing segments 24 coupled together, e.g., in a coil. Mixing section 22 has a total length (L), aspect ratio (AR), and/or volumetric flow rate (Q) providing a residence time (RT) sufficient for rapid streamline mixing. The aspect ratio of mixing section 22 is given by equation [2]:

$$Aspect Ratio = \frac{( L )}{( D )} \qquad [ 2 ]$$

where L is the length and D is the inner bore diameter, respectively. Aspect ratios are selected having values greater than about 100. More particularly, aspect ratios are selected having values greater than about 500. Average Residence Time is determined from equation [3]:

$$Residence Time = \frac{( V )}{( Q )} \qquad [ 3 ]$$

where V is the total volume (mL) and Q is the volumetric flow rate (mL/min) of mixing section 22, respectively. Residence time is selected in the range from about 0.01 min (0.5 sec) to about 1.0 min. More particularly, residence time is selected in the range from about 0.03 min (2 sec) to about 0.17 min (10 sec) achieving rapid mixing of fluids.

In the instant embodiment, at least one mixing segment 26 is positioned to generate flow in a first direction (e.g., down) and at least one mixing segment 28 is positioned to generate flow in a second direction (e.g., up). As illustrated in the figure, introduction (injection) of fluid 16 into fluid 14 generates a density gradient directionally opposed to the flow of bulk fluid 14 having a vector (ρ) 10 oriented substantially vertically up, inducing a new velocity vector (v) 12 oriented substantially vertically down. Direction of flow of bulk fluid 14 changes in mixing segment 28 whereby vector 10 of the density gradient orients substantially vertically down, inducing a new velocity vector 12 oriented substantially vertically down, but is not limited thereto. In the instant configuration, mixing section 22 has a length (L) of about 24 inches, an inner diameter of about 0.060 inches, and an inner volume of about 1.11 mL, yielding an aspect ratio of 400 and a residence time of about 2.6 seconds, but is not limited thereto. As will be readily understood by those of skill in the art, dimensions are variable to achieve rapid mixing as described herein. No limitations are intended. For example, mixing segments 24 may be coupled in series without limitation, yielding additional coils for mixing that yield a substantially homogeneous mixed fluid. In an alternate configuration (not shown), mixing section 22 may comprise a single vertical mixing segment 24 positioned to generate flow in either an upward or a downward direction, again not being limited thereto.

FIG. 2b illustrates a mixing apparatus 22 (section) for mixing of fluids, according to another embodiment of the invention. Mixing section 22 comprises any number of substantially vertically disposed mixing segments 24 coupled together, e.g., in a coil. In the instant embodiment, fluids introduced to mixing section 22 enter mixing segment 26 with a fluid flow in a substantially vertically upward direction. Introduction (injection) of fluid 16 into fluid 14 generates a density gradient directionally opposed to the flow of fluid with a vector (ρ) 10 oriented substantially vertically down, inducing a new velocity vector (v) 12 oriented substantially vertically down. Direction of fluid flow changes in mixing segment 28 whereby vector 10 of the density gradient orients substantially vertically up, inducing a new velocity vector 12 oriented substantially vertically down, but is not limited thereto. Mixing segments 24 may be coupled in series without limitation, yielding additional coils for mixing that yield a substantially homogeneous mixed fluid. No limitations are intended. For example, in an alternate configuration (not shown), mixing section 22 can comprise a single substantially vertical mixing segment 24 positioned to generate flow in either an upward or a downward direction, again not being limited thereto.

FIG. 3 illustrates a mixing section 22 for mixing fluids in conjunction with a mixing device or system, according to yet another embodiment of the invention. Mixing section 22 is of a sinusoidal form comprising any number of substantially vertically disposed mixing segments 24 coupled together, but is not limited thereto. At least one mixing segment 26 is positioned to generate fluid flow in a first direction (e.g., up or down) and at least one mixing segment 28 is positioned to generate fluid flow in a second direction thereby achieving thorough and rapid mixing. In the instant embodiment, fluids entering mixing section 22 enter mixing segment 26 flowing in an upward direction, generating a density gradient having a vector (ρ) 10 oriented in a substantially vertically down direction and inducing a new velocity vector (v) 12 oriented substantially vertically down. Direction of fluid flow changes in mixing segment 28 whereby vector 10 of density gradient orients substantially vertically up, inducing a new velocity vector 12 oriented substantially vertically down, but is not limited thereto. In an alternate configuration (not shown), mixing apparatus 22 is configured such that fluid(s) entering device 22 flow first in a downward direction generating a density gradient with vector 10 oriented in a substantially vertically up direction inducing a new velocity vector 12 oriented in a substantially vertically down direction. Pairs of mixing segments 24 may be coupled in series without limitation thus extending the sinusoidal apparatus and propagating the density gradient and velocity vector patterns described herein until the fluid is thoroughly mixed forming a substantially homogeneous mixed fluid. No limitations are hereby intended.

FIG. 4 illustrates a mixing apparatus 22 (section) for mixing fluids in conjunction with a mixing device or system, according to yet another embodiment of the invention. Mixing section 22 is of an angular shape comprising any number of substantially vertically disposed mixing segments 24 coupled together. At least one mixing segment 26 is positioned to generate fluid flow in a first direction with another mixing segment 28 positioned to generate flow in a second direction, mixing segments 26 and 28 disposed at an angle “θ” with respect to one another whereby thorough mixing is achieved. Acute values for “θ” are preferred but are not limited thereto. In the instant embodiment, fluids entering mixing section 22 enter mixing segment 26 flowing in a upward direction, generating a density gradient having a vector (ρ) 10 oriented in a substantially vertically down direction and inducing a new velocity vector (v) 12 oriented substantially vertically down. Fluid flow reverses direction in mixing segment 28 whereby vector 10 of the density gradient orients substantially vertically up inducing a new velocity vector 12 oriented substantially vertically down, but is not limited thereto. In an alternate configuration (not shown), mixing apparatus 22 is configured such that fluid(s) entering device 22 flow first in a downward direction generating a density gradient having a vector 10 oriented in a substantially vertically up direction and inducing a new velocity vector 12 oriented in a substantially vertically down direction. Pairs of mixing segments 24 may be coupled in series without limitation extending the angular apparatus thereby providing for repeating density gradient and velocity patterns described herein until the fluid is thoroughly mixed providing a substantially homogeneous mixed fluid. No limitations are hereby intended. Other configurations as will be envisioned by those of skill in the art are encompassed herein. No limitations are intended.

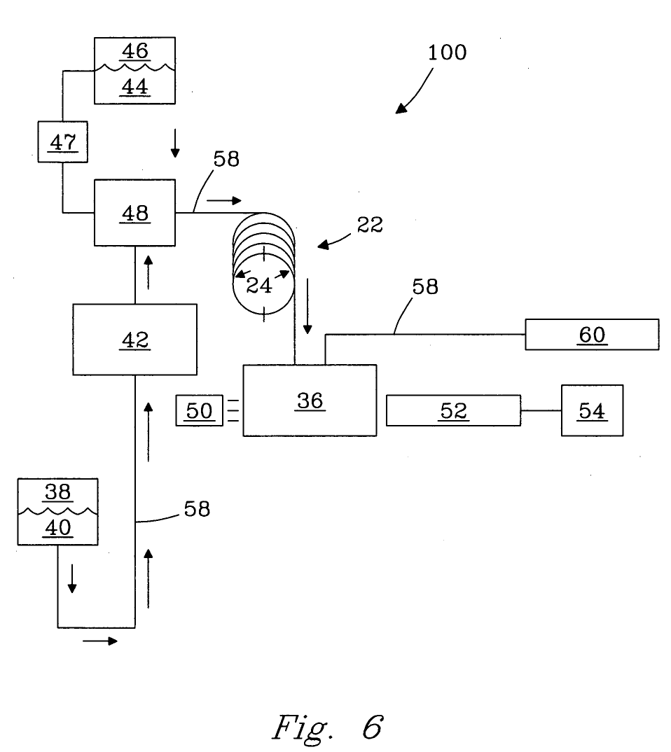

FIG. 5 illustrates a mixing apparatus 22 (section) for mixing fluids in conjunction with a mixing device or system, according to yet another embodiment of the invention. Mixing section 22 is of a rectangular shape comprising any number of substantially vertically disposed mixing segments 24 coupled together. At least one mixing segment 26 is positioned to generate fluid flow in a first direction (e.g., up or down) and at least one mixing segment 28 is positioned to generate fluid flow in a second direction (e.g., down or up) whereby thorough mixing is achieved. In the instant embodiment, fluids entering mixing section 22 enter mixing segment 26 flowing in a upward direction generating a density gradient having a vector (ρ) 10 oriented in a substantially vertically down direction and inducing a new velocity vector (v) 12 oriented in a substantially vertically down direction. Fluid flow reverses direction in mixing segment 28 whereby the vector 10 of the density gradient orients in a substantially vertically up direction and inducing a new velocity vector 12 oriented in a substantially vertically down direction, but is not limited thereto. In an alternate configuration (not shown), mixing apparatus 22 is configured such that fluid(s) entering device 22 flow first in a downward direction generating a density gradient having a vector 10 oriented in a substantially vertically up direction and inducing a new velocity vector 12 oriented in a substantially vertically down direction. As described previously, mixing segments 24 may be coupled in series without limitation extending the rectangular apparatus thereby providing for repeating density gradient and velocity patterns until the fluid is thoroughly mixed providing a substantially homogeneous mixed fluid. Other configurations as will be envisioned by those of skill in the art are encompassed herein. No limitations are intended. As with other configurations, mixing section 22 has a length, aspect ratio, flow rate, and residence time sufficient to achieve mixing, as described herein. A complete mixing system will now be described with reference to FIG. 6.

FIG. 6 illustrates a complete mixing system 100, according to an embodiment of the invention. In the figure, mixing system 100 comprises a mixing section 22 having any number of substantially vertical mixing segments 24 coupled together in the shape of a coil. Mixing section 22 was operatively coupled to an optional view cell 36 for viewing mixing efficiency. Mixing was assessed in conjunction with refractive index measurements. In particular, view cell 36 was configured with two ½-inch optical windows through which mixing of solutions could be viewed via a transmission image using a near-point light source 50 coupled to a video camera 52 equipped with a standard macro or telescopic lens, and to a standard video display 54 positioned adjacent to view cell 36. Refractive index differences in unmixed fluid(s) were visually observed as fluctuating distortions in the transmitted image. Refractive index differences are a direct result of density gradients in an unmixed fluid. When complete mixing is achieved, no distortions in the transmitted image are observed. Other suitable means to assess adequacy of mixing may be used without limitation.

Mixing section 22 was further coupled to a fluid reservoir or vessel 38 containing a surfactant fluid 40 (described hereinafter) for on-demand injection and mixing. Mixing section 22 was further coupled to pump 42 (e.g., a model BBB-4 HPLC-style reciprocating piston pump, Eldex Laboratories, Inc., San Carlos, Calif.) for delivering fluid 40 to mixing section 22 at a rate in the range from about 1 to 5 mL/min, but was not limited thereto. Pure densified CO₂ 44 (ρ˜0.89 g/cc) was delivered from feed source 46 (e.g., cylinder) to mixing section 22 via feed pump 47 (e.g., a microprocessor-controlled syringe pump, ISCO, Inc., Lincoln, NB) at a rate of 25 mL/min under a pressure of 2500 psi and a temperature of 25° C. through a combination “T” fitting 48 into mixing section 22 and into view cell 36. Mixing of fluid 40 and fluid 44 was ascertained in conjunction with refractive index measurements. System 100 components were linked via standard 1/16-inch O.D. stainless steel tubing 58. Waste fluids were collected in a collection vessel 60.

In one exemplary surfactant fluid 40, 5.3 mL of perfluoropolyether (PFPE) phosphate acid surfactant (ρ˜1.5 g/cc) (Solvay Solexis, Inc., Thorofare, N.J.), 2 g sodium AOT sulfonate co-surfactant (ρ˜1.0 g/cc) (Aldrich Chemical Company, Milwaukee, Wis. 53201), 0.33 mL de-ionized, distilled H₂O were premixed in a co-solvent of 10.6 mL dichloropentafluoropropane (ρ˜1.6 g/cc) (HCFC-225®) (AGA Chemicals, Charlotte, N.C.) or other suitable carrier or co-solvent yielding an approximate 1:1 surfactant:solvent solution (overall ρ˜1.5 g/cc), but is not limited thereto. For example, other ratios of surfactant:solvent may be used without limitation. In addition, other surfactants and/or reactive reagents may be combined, e.g., as described in co-pending application (U.S. application Ser. No. 10/783,249) and used in conjunction with the present invention including, e.g., PFPE-phosphate/AOT in a co-solvent comprising polychlorotrifluoroethylene in halocarbon oil, PFPE-phosphate/AOT in a co-solvent comprising trifluoro-trichloro ethane (CFC-113®). Other surfactants and/or reactive reagents may be premixed in a suitable co-solvent for on-demand injection, including e.g., PFPE-ammonium carboxylate/hydroxylamine in HCFC-2250®, PFPE-ammonium carboxylate/hydroxylamine in polychlorotrifluoroethylene (halocarbon oil). No limitations are hereby intended.

While the present invention has been described herein with reference to particular and/or preferred embodiments, it should be understood that the invention is not limited thereto. Various alternatives in form and detail may be made therein without departing from the spirit and scope of the invention. For example, cross-sectional shape of mixing segments 24 can be of any form including, but not limited to, annular, oval, square, rectangular, triangular, octagonal, or other “n-gonal” shape, including combinations thereof.

Those of skill in the art will further appreciate that combining and intermixing of various fluids and reactive components as currently practiced and described herein may be effected in numerous and effectively equivalent ways. For example, application of the methods described herein on a commercial scale may comprise high-pressure pumps and pumping systems, and/or transfer systems for moving, transporting, transferring, combining, intermixing, as well as delivering and applying various mixed fluids for various fabrication applications, e.g., cleaning and rinsing. In addition, commercial components for mixing and/or delivery of fluids described herein may be further controlled in conjunction with computer-controlled systems and/or devices.

Further, associated application and/or processing techniques for utilizing mixed fluids of the invention described herein relative to substrate surface processing, e.g., cleaning, will include those aspects envisioned by those of skill in the art. In general, many changes and modifications may be made without departing from the invention in its broader aspects. No limitations are hereby intended.

We claim:

1. An apparatus for rapid mixing of fluids, comprising:
at least one inlet for introducing a fluid or a plurality of fluids into a near-critical or super-critical carrier fluid forming a fluid stream, wherein said carrier fluid is a gas at standard temperature and pressure having a density above the critical density for said carrier fluid;
an outlet for retrieving a substantially homogeneous mixed fluid; and,
a mixing section operably disposed between said at least one inlet and said outlet having an inner bore of substantially uniform dimension generating a density gradient upon introduction of said fluid or said plurality of fluids, said density gradient inducing a convective velocity in said stream that rapidly mixes said fluid or said plurality of fluids forming said substantially homogenous mixed fluid.

2. The apparatus of claim 1, wherein said carrier fluid comprises a member selected from the group consisting of carbon dioxide, ethane, ethylene, propane, butane, sulfurhexafluoride, Freon®, nitrogen, ammonia, substituted derivatives thereof, or combinations thereof.

3. The apparatus of claim 1, wherein said carrier fluid is a liquid having a reduced temperature of greater than about 0.75.

4. The apparatus of claim 1, wherein said density gradient is directionally opposed to the direction of flow of said carrier fluid.

5. The apparatus of claim 1, wherein said convective velocity has a directional vector oriented parallel to the direction of flow of said carrier fluid.

6. The apparatus of claim 1, wherein said convective velocity is directionally opposed to the direction of flow of said carrier fluid.

7. The apparatus of claim 1, wherein said density gradient is directionally opposed to said convective velocity in said fluid stream.

8. The apparatus of claim 1, wherein said density gradient is generated in conjunction with a concentration difference(s) between at least a first and a second fluid in said fluid stream.

9. The apparatus of claim 1, wherein said density gradient is generated in conjunction with a temperature difference(s) between at least a first and a second fluid in said fluid stream.

10. The apparatus of claim 1, wherein said fluid or said plurality of fluids have a residence time in said mixing section in the range from about 0.01 minutes to about 1.0 minutes.

11. The apparatus of claim 1, wherein said fluid or said plurality of fluids have a residence time in said mixing section in the range from about 2 seconds to about 10 seconds.

12. The apparatus of claim 1, wherein said fluid or said plurality of fluids are introduced at flow rate in the range from about 10 mL/min to about 10 L/min.

13. The apparatus of claim 1, wherein said fluid or said plurality of fluids are introduced at a flow rate in the range from about 25 mL/min to about 1 L/min.

14. The apparatus of claim 1, wherein said mixing section has an aspect ratio greater than about 100.

15. The apparatus of claim 1, wherein said mixing section has an aspect ratio greater than about 500.

16. The apparatus of claim 1, wherein said fluid or said plurality of fluids exhibit a density difference compared to said carrier fluid in the range from about 0.5 percent to about 50 percent.

17. The apparatus of claim 1, wherein said fluid or said plurality of fluids exhibit a density difference compared to said carrier fluid in the range from about 1 percent to about 20 percent.

18. The apparatus of claim 1, wherein said mixing section comprises a plurality of substantially vertically disposed mixing segments operatively coupled having a shape selected from the group consisting of coil, sinusoidal, rectangular, angular, or combinations thereof.

19. The apparatus of claim 1, wherein said mixing section comprises a single mixing segment substantially vertically disposed whereby said gradient is generated in either an upward or a downward direction.

20. The apparatus of claim 1, wherein at least one of said plurality of fluids comprises at least one solute dissolved in a co-solvent for introducing said solute in a substantially liquefied form.

21. The apparatus of claim 20, wherein the ratio of said solute to said co-solvent is selected in the range from about 0.1:1 to about 10:1.

22. The apparatus of claim 20, wherein the ratio of said solute to said co-solvent is selected in the range from about 1:1 to about 5:1.

23. The apparatus of claim 20, wherein said co-solvent is selected from the group consisting of dichloro-pentafluoro-propane, dichloro-pentafluoro-pentane, polychlorotrifluoroethylene, trifluoro-trichloro ethane, dihydrodecafluoropentane, diethylether, or combinations thereof.

24. The apparatus of claim 20, wherein said at least one solute comprises a surfactant or co-surfactant selected from the group consisting of CO₂-philic, anionic, cationic, non-ionic, zwitterionic, reverse-micelle-forming surfactants and co-surfactants, and combinations thereof.

25. The apparatus of claim 24, wherein said anionic surfactants are selected from the group consisting of fluorinated hydrocarbons, fluorinated surfactants, non-fluorinated surfactants, PFPE surfactants, PFPE carboxylates, PFPE ammonium carboxylates, PFPE phosphate acids, PFPE phosphates, fluorocarbon carboxylates, PFPE fluorocarbon carboxylates, PFPE sulfonates, PFPE ammonium sulfonates, fluorocarbon sulfonates, fluorocarbon phosphates, alkyl sulfonates, sodium bis-(2-ethyl-hexyl) sulfosuccinates, ammonium bis-(2-ethyl-hexyl) sulfosuccinates, and combinations thereof.

26. The apparatus of claim 24, wherein said cationic surfactants are selected from the class of tetra-octyl-ammonium fluoride compounds.

27. The apparatus of claim 24, wherein said non-ionic reverse micelle forming surfactants are selected from the class of poly-ethylene-oxide-dodecyl-ether compounds, their substituted derivatives, and functional equivalents thereof.

28. The apparatus of claim 24, wherein said zwitterionic reverse micelle forming surfactants are selected from the class of alpha-phosphatidyl-choline compounds, their substituted derivatives, and functional equivalents thereof.

29. The apparatus of claim 24, wherein said reverse-micelle-forming co-surfactants are selected from the group consisting of alkyl acid phosphates, alkyl acid sulfonates, alkyl alcohols, perfluoroalkyl alcohols, dialkyl sulfosuccinate surfactants, derivatives, salts, and functional equivalents thereof.

30. The apparatus of claim 24, wherein said reverse-micelle-forming co-surfactants are selected from the group consisting of sodium bis-(2-ethyl-hexyl) sulfosuccinates, ammonium bis-(2-ethyl-hexyl) sulfosuccinates, and equivalents thereof.

31. The apparatus of claim 20, wherein said at least one of said plurality of fluids further comprises a reactive chemical agent selected from the group consisting of ethanolamine, hydroxylamine, peroxides, organic peroxides, hydrogen peroxide, alcohols, water, or combinations thereof.

32. The apparatus of claim 1, wherein said apparatus is a component of a wafer manufacturing system or device.

33. A method for mixing a fluid or a plurality of fluids, comprising:
introducing a fluid or a plurality of fluids into a near-critical or super-critical carrier fluid forming a fluid stream, wherein said carrier fluid is a gas at standard temperature and pressure having a density above the critical density for said carrier fluid, wherein a density gradient is generated upon introduction of said fluid or a said plurality of fluids, said density gradient inducing a convective velocity rapidly mixing said fluid or said plurality of fluids in said stream.

34. The method of claim 33, wherein said carrier fluid comprises a member selected from the group consisting of carbon dioxide, ethane, ethylene, propane, butane, sulfurhexafluoride, Freon®, nitrogen, ammonia, substituted derivatives thereof, or combinations thereof.

35. The method of claim 33, wherein said carrier fluid has a reduced temperature of greater than about 0.75.

36. The method of claim 33, wherein said density gradient is directionally opposed to the direction of flow of said carrier fluid.

37. The method of claim 33, wherein said convective velocity has a directional vector oriented parallel to the direction of flow of said carrier fluid.

38. The method of claim 33, wherein said convective velocity is directionally opposed to the direction of flow of said carrier fluid.

39. The method of claim 33, wherein said density gradient is directionally opposed to said convective velocity in said fluid stream.

40. The method of claim 33, wherein said density gradient is generated in conjunction with a concentration difference(s) between at least a first and a second fluid in said fluid stream.

41. The method of claim 33, wherein said density gradient is generated in conjunction with a temperature difference(s) between at least a first and a second fluid in said plurality of fluids.

42. The method of claim 33, wherein said fluid or said plurality of fluids have a residence time in said mixing section in the range from about 0.01 minutes to about 1.0 minutes.

43. The method of claim 33, wherein said fluid or said plurality of fluids have a residence time in said mixing section in the range from about 2 seconds to about 10 seconds.

44. The method of claim 33, wherein said fluid or said plurality of fluids are introduced into said stream at a flow rate in the range from about 10 mL/min to about 10 L/min.

45. The method of claim 33, wherein said fluid or said plurality of fluids are introduced into said stream at a flow rate in the range from about 25 mL/min to about 1 L/min.

46. The method of claim 33, wherein said fluid or said plurality of fluids are introduced into said stream in a mixing device having an aspect ratio of greater than about 100.

47. The method of claim 33, wherein said fluid or said plurality of fluids are introduced into said stream in a mixing device having an aspect ratio of greater than about 500.

48. The method of claim 33, wherein said fluid or said plurality of fluids are introduced into a mixing device comprising a tube substantially vertically disposed for generating a flow in either a substantially upward or a substantially downward direction.

49. The method of claim 33, wherein said fluid or said plurality of fluids exhibit a density difference compared to said carrier fluid in the range from about 0.5 percent to about 50 percent.

50. The method of claim 33, wherein said fluid or said plurality of fluids exhibit a density difference compared to said carrier fluid in the range from about 1 percent to about 20 percent.

51. The method of claim 33, wherein at least one of said plurality of fluids comprises at least one solute dissolved in a co-solvent for introducing said solute in a substantially liquefied form.

52. The method of claim 51, wherein the ratio of said solute to said co-solvent is selected in the range from about 0.1:1 to about 10:1.

53. The method of claim 51, wherein the ratio of said solute to said co-solvent is selected in the range from about 1:1 to about 5:1.

54. The method of claim 51, wherein said co-solvent is selected from the group consisting of dichloro-pentafluoro-propane, dichloro-pentafluoro-pentane, polychlorotrifluoroethylene, trifluoro-trichloro ethane, dihydrodecafluoropentane, diethylether, or combinations thereof.

55. The method of claim 51, wherein said at least one solute is a surfactant selected from the group consisting of CO₂-philic, anionic, cationic, non-ionic, zwitterionic, reverse-micelle-forming surfactants and co-surfactants, and combinations thereof.

56. The method of claim 55, wherein said anionic surfactants are selected from the group consisting of fluorinated hydrocarbons, fluorinated surfactants, non-fluorinated surfactants, PFPE surfactants, PFPE carboxylates, PFPE ammonium carboxylates, PFPE phosphate acids, PFPE phosphates, fluorocarbon carboxylates, PFPE fluorocarbon carboxylates, PFPE sulfonates, PFPE ammonium sulfonates, fluorocarbon sulfonates, fluorocarbon phosphates, alkyl sulfonates, sodium bis-(2-ethyl-hexyl) sulfosuccinates, ammonium bis-(2-ethyl-hexyl) sulfosuccinates, and combinations thereof.

57. The method of claim 55, wherein said cationic surfactants are selected from the class of tetra-octyl-ammonium fluoride compounds.

58. The method of claim 55, wherein said non-ionic reverse micelle forming surfactants are selected from the class of poly-ethylene-oxide-dodecyl-ether compounds, their substituted derivatives, and functional equivalents thereof.

59. The method of claim 55, wherein said zwitterionic reverse micelle forming surfactants are selected from the class of alpha-phosphatidyl-choline compounds, their substituted derivatives, and functional equivalents thereof.

60. The method of claim 55, wherein said reverse-micelle-forming co-surfactants are selected from the group consisting of alkyl acid phosphates, alkyl acid sulfonates, alkyl alcohols, perfluoroalkyl alcohols, dialkyl sulfosuccinate surfactants, derivatives, salts, and functional equivalents thereof.

61. The method of claim 55, wherein said reverse-micelle-forming co-surfactants are selected from the group consisting of sodium bis-(2-ethyl-hexyl) sulfosuccinates, ammonium bis-(2-ethyl-hexyl) sulfosuccinates, and equivalents thereof.

62. The method of claim 51, wherein said at least one of said plurality of fluids further comprises a reactive chemical agent selected from the group consisting of ethanolamine, hydroxylamine, peroxides, organic peroxides, hydrogen peroxide, alcohols, water, or combinations thereof.

63. The method of claim 33, wherein said mixing is done in conjunction with a mixing system or device.

64. The method of claim 63, wherein said mixing system or device is a component of a wafer fabrication or semiconductor manufacturing system or device.
